(19) United States
(12) Patent Application Publication
(10) Pub. No.: US 2024/0360037 A1
(43) Pub. Date: Oct. 31, 2024

(54) LOW-CARBON EMISSION MINERAL CASTING MATERIAL AND MANUFACTURING METHOD THEREOF, AND EQUIPMENT INCLUDING LOW-CARBON EMISSION MINERAL CASTING ELEMENT

(71) Applicant: WINSON MACHINERY CO., LTD., Changhua County (TW)

(72) Inventor: Yi-hsuan HSIEH, Changhua County (TW)

(73) Assignee: WINSON MACHINERY CO., LTD., Changhua County (TW)

(21) Appl. No.: 18/645,512

(22) Filed: Apr. 25, 2024

(30) Foreign Application Priority Data
Apr. 26, 2023 (TW) 112115635

(51) Int. Cl. C04B 28/06; C04B 14/04; C04B 28/04; C04B 111/00

(52) U.S. Cl. CPC C04B 28/06; C04B 14/04; C04B 28/04; C04B 2111/00017; C04B 2201/32; C04B 2201/52

(57) ABSTRACT

A low-carbon emission mineral casting material and a manufacturing method thereof, and an equipment including a low-carbon emission mineral casting are provided. The low-carbon emission mineral casting material includes a bonding agent, a first aggregate, and an additive agent. The bonding agent includes one or more of silicate, aluminate, or iron-aluminate. A first particle diameter of the first aggregate is less than or equal to 15 mm. The low-carbon emission mineral casting material provided by the present application has better heat resistance, lower thermal conductivity, lower expansion coefficient, and better shock-absorbing performance than traditional casting material.

### CROSS REFERENCE TO RELATED APPLICATIONS

The present application claims priority of the Taiwan Patent Application No. 112115635, filed on Apr. 26, 2023 with the Taiwan Intellectual Property Office, which is incorporated by reference in the present application in its entirety.

### FIELD OF INVENTION

The present invention relates to a low-carbon emission mineral casting material and its manufacturing method and equipment containing low-carbon emission mineral castings.

### BACKGROUND OF INVENTION

A casting technology generally used for industrial parts mostly involves a heating of metal. However, in currently pursuit of environmental protection, this production method will emit a large amount of carbon dioxide, thus causing a product to have a large carbon footprint.

In addition, traditional metal casting methods often require pouring molten metal into a mold, and then the casting can be formed only after the metal is cooled and solidified. However, those of ordinary skill in the art will understand that heating metals to a molten state requires a large amount of energy and thus increases carbon emissions.

To further explain, a manufacturing of metal materials, such as smelting, requires a large amount of carbon emissions. Therefore, every step in the manufacturing process of casting products produces a large amount of carbon emissions, which is very inconsistent with the environmental protection trends nowadays. In addition, due to limitations in the manufacturing process of metal materials, casting materials produced in the past were often difficult to maintain casting strength at high temperatures. As a result, it is difficult to break through the mechanical characteristics of precision machinery that needs to operate in high-temperature and high-pressure environments.

Therefore, a new casting material and a manufacturing method thereof are needed to solve the above-mentioned conventional problems.

### SUMMARY OF INVENTION

Based on the above purpose, the present application provides a low-carbon emission mineral casting material, including a binder, a first aggregate, and an additive. The binder includes one or more of silicate, aluminate, or ferroaluminate. The first particle diameter of the first aggregate is less than or equal to 15 mm.

Preferably, in one embodiment, the first particle diameter of the first aggregate ranges from 5 mm to 3 mm.

Preferably, in one embodiment, the first aggregate is a hard stone in an air-dry state that is in an air-dry state and is a dust-free, angular hard stone.

Preferably, in one embodiment, the first aggregate is one or more of gabbro, granite, basalt, andesite, conglomerate, sandstone, shale, diabase, pyroxene rock, or quartz.

Preferably, in one embodiment, further includes a second aggregate, a second particle diameter of the second aggregate is less than 3 mm.

Preferably, in one embodiment, the first aggregate is in an air-dry state and is a dust-free, angular hard stone.

Preferably, in one embodiment, the silicate is one or more of tricalcium silicate and dicalcium silicate; wherein the aluminate is tricalcium aluminate, and wherein the iron aluminate is tetracalcium ferroaluminate.

Preferably, the additive includes a cement modifier and a concrete shrinkage modifier.

Preferably, in one embodiment, the low-carbon emission mineral casting material forms a casting with a thermal conductivity coefficient ranges from 2 W·m⁻¹K⁻¹ to 7 W·m⁻¹K⁻¹, and a specific heat capacity ranges from 0.7 Kj·kg⁻¹K⁻¹ to 1.5 Kj·kg⁻¹K⁻¹, and a linear thermal expansion coefficient ranges from 5 10⁻⁶/K to 15 10⁻⁶/K, and a compressive strength greater than 125 MPa, a flexural strength greater than 15 MPa, and a Young's modulus greater than 40,000 MPa, and a density ranges from 2 g·cm⁻³ to 3 g·cm⁻³.

Preferably, in one embodiment, a weight percentage of the first aggregate and the second aggregate in the low-carbon emission mineral casting material ranges from 0% to 80%, wherein a weight percentage of the binder in the low-carbon emission mineral casting material ranges from 35% to 45%, and wherein a weight percentage of the additives in the low-carbon emission mineral casting material ranges from 2% to 8%.

Based on the above purpose, the present application further provides a method of manufacturing a low-carbon emission mineral casting materials, which includes the following steps: cracking one ore raw material to form a plurality of broken ore raw materials; screening the plurality of broken ore raw materials according to a first particle diameter to obtain a first aggregate; for the first aggregate; and mixing the first aggregate, a binder, an additive and water to form the low carbon ore casting material; wherein the binder includes tricalcium silicate, dicalcium silicate, tricalcium aluminate, and tetracalcium ferroaluminate, wherein a first particle diameter of the first aggregate is less than or equal to 15 mm, wherein the low carbon ore casting material is casting at room temperature, and wherein a mold is filled under natural flow and solidified to form a low-carbon emission mineral casting.

Preferably, in one embodiment, the first particle diameter of the first aggregate ranges from 5 mm to 12 mm.

Preferably, in one embodiment, the first aggregate is one or more of gabbro, granite, basalt, andesite, conglomerate, sandstone, shale, diabase, pyroxene rock, or quartz.

Preferably, in one embodiment, the first aggregate is a hard stone.

Preferably, in one embodiment, a weight percentage of the first aggregate and the second aggregate in the low-carbon emission mineral casting material ranges from 0% to 80%, wherein a weight percentage of the binder in the low-carbon emission mineral casting material ranges from 35% to 45%, and wherein a weight percentage of water in the low-carbon emission mineral casting material ranges from 5% to 12%.

Preferably, in one embodiment, the low-carbon emission mineral casting material forms a casting with a thermal conductivity coefficient ranges from 2 W·m⁻¹K⁻¹ to 7 W·m⁻¹K⁻¹, and a specific heat capacity ranges from 0.7 Kj·kg⁻¹K⁻¹ to 1.5 Kj·kg⁻¹K⁻¹, and a linear thermal expansion coefficient ranges from 5 10⁻⁶/K to 15 10⁻⁶/K, and a compressive strength greater than 125 MPa, a flexural strength greater than 15 MPa, and a Young's modulus greater than 40,000 MPa, and a density ranges from 2 g·cm⁻³ to 3 g·cm⁻³.

Based on the above purpose, the present application further provides an equipment containing low-carbon emission mineral castings, including a low-carbon emission mineral casting and a working device. The low-carbon emission mineral casting is made of the low-carbon emission mineral casting material in any of the above embodiments. The working device is connected to low carbon mineral casting.

The present application provides low-carbon emission mineral casting materials and manufacturing methods thereof. Since the processing of ores can significantly reduce carbon emissions compared to the manufacturing of metal materials, it is more economical and environmentally friendly. In addition, the low-carbon emission mineral casting material of the present application does not need to be heated to form a molten state during the process of forming the casting, so it can further save energy and effectively reduce the carbon footprint of the end product. In addition to low carbon emission during the production process, the low-carbon emission mineral casting material provided by the present application can replace cast iron. Moreover, the low-carbon emission mineral casting material provided by the present application also has better heat resistance, lower thermal conductivity, lower expansion coefficient, and better shock-absorbing performance.

### DESCRIPTION OF FIGURES

FIG. 1 is a first schematic diagram of a low-carbon emission mineral casting material according to one embodiment of the present application.

FIG. 2 is a second schematic diagram of a low-carbon emission mineral casting material according to one embodiment of the present application.

FIG. 3 is a comparison chart of material properties of low-carbon emission mineral casting materials and other materials according to one embodiment of the present application.

FIG. 4 is a schematic diagram of equipment containing low-carbon emission mineral castings according to one embodiment of the present application.

### DETAILED DESCRIPTION OF EMBODIMENTS

In order to help the examiner understand the technical features, content and advantages of this application and the effects it can achieve, this application is described in detail below with the accompanying drawings and in the form of embodiments. The diagrams used are for illustration and auxiliary explanation only. It may not be the actual proportion and precise configuration after the implementation of this application. Therefore, the proportion and arrangement relationship of the attached drawings should not be interpreted or limited to the scope of rights in actual implementation of the present application, which shall be explained in advance.

The following will describe the embodiments of the present application with reference to the relevant figures. To facilitate understanding, the same components in the following embodiments are labeled with the same symbols.

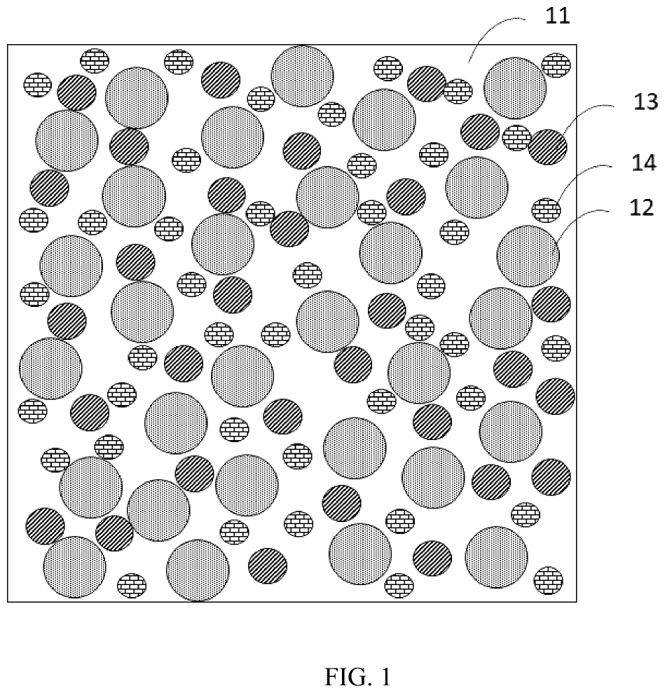

As shown in FIG. 1, the low-carbon emission mineral casting material of the present application includes a binder 11, a first aggregate 12, and an additive 14. It is further explained that after the binder 11, the first aggregate 12, and the additive 14 are mixed and stirred, there is no need to heat the low-carbon emission mineral casting material of the present application. The low-carbon emission mineral casting material of the present application only needs to be poured into the mold and then solidified to form a casting. In particular, it can be used for castings such as bases, lathe beds, beams, machine columns, spindle heads, fuselages, workbenches, etc. of tool machines or other instruments.

To further illustrate, the adhesive 11 may include one or more of silicate, aluminate, or iron aluminate. In some embodiments, the silicate can be one or more of tricalcium silicate and dicalcium silicate, wherein the aluminate can be tricalcium aluminate, and the ferroaluminate may be tetracalcium ferroaluminate, but is not limited thereto.

In one preferred embodiment, the adhesive 11 may include silicate, aluminate, and ferroaluminate, wherein the silicate can be tricalcium silicate and dicalcium silicate, and wherein the aluminate can be tricalcium aluminate, and wherein the ferroaluminate can be tetracalcium ferroaluminate.

To further explain, the first particle diameter of the first aggregate 12 is less than or equal to 15 mm. In one embodiment, in order to further enhance the structure, the low-carbon emission mineral casting material of the present application may also include a second aggregate 13. The second particle diameter of the aggregate 13 is less than the first particle diameter of the first aggregate 12. In other words, since the particle diameters of the first aggregate 12 and the second aggregate 13 in the low-carbon emission mineral casting material of the present application are both very small, the different particle diameters of the constituent materials of the low-carbon emission mineral casting material of the present application can be optimally proportioned to form the densest packing, so that the subsequently formed castings have excellent physical and mechanical properties.

In one embodiment, the first particle diameter of the first aggregate 12 ranges from 5 mm to 12 mm, for example, it can be 5 mm, 6 mm, 7 mm, 8 mm, 9 mm, 10 mm, 11 mm or 12 mm, or it can be any particle diameter within these ranges, but not limited thereto. In one embodiment, preferably, the particle diameter of the first aggregate 12 ranges from 5 mm to 10 mm.

To further explanation, in another embodiment, the first aggregate 12 is a hard stone in an air-dry state, and the first aggregate 12 is one or more of gabbro, granite, basalt, andesite, conglomerate, sandstone, shale, diabase, pyroxenite, or quartz. In other words, the first aggregate 12 composed of one or more hard stones can be used.

In one embodiment, the first aggregate 12 can be naturally air-dried or otherwise formed into an air-dried state. In other embodiments, the first aggregate 12 is a dust-free hard stone with edges and corners. That is to say, in the present application, the mineral raw material only needs to go through processes such as drying, crushing, dust removal, cleaning, and particle diameter screening (the order can be adjusted according to actual needs and is not limited) to obtain the first aggregate 12. A shape of the first aggregate 12 is not limited, so the processing process of the aggregate shape can be eliminated.

In one embodiment, the second particle diameter of the second aggregate 13 is less than 3 mm, for example, it can be 1 mm, 2 mm, 3 mm, or any particle diameter ranges from 0 mm to 3 mm. Preferably, the second aggregate 13 may be in an air-dry state and be dust-free and angular sandy material. To further explain, in one embodiment, the second aggregate 13 may be natural sand or artificial sand, and its main material may be silica.

In other embodiments, the second aggregate 13 may also include other substances. For example, the second aggregate 13 may also include one or more of slag, sea sand, and coral sand. In other words, one or more of slag, sea sand, and coral sand can partially or completely replace the sandy material mainly composed of silica.

In one embodiment, the additive 14 may include one or more of a cement modifier and a concrete shrinkage modifier. For example, the cement modifier can be a high-performance water reducing agent, etc., and the concrete shrinkage modifier can be a magnesium oxide expansion agent, a high-performance concrete expansion agent, etc.

In addition, in one embodiment, in terms of weight percentage, the weight percentage of the first aggregate 12 and the second aggregate 13 in the low-carbon emission mineral casting material may ranges from 0% to 80%. Preferably, in terms of weight percentage of the low-carbon casting material of the present application, the binder 11 can range from 35% to 45%, the first aggregate 12 and the second aggregate 13 can range 35% to 45%, the water can range 5% to 12%, and additives can range from 2% to 8%. To further explain, in a preferred embodiment, the weight percentage of the first aggregate 12 and the second aggregate 13 may be about 50%.

The present application further provides a method of manufacturing a low-carbon emission mineral casting material, including the following steps:
cracking an mineral raw material to form a plurality of broken mineral raw materials;
screening the plurality of broken mineral raw materials according to a first particle diameter to obtain a first aggregate 112;
removing dust and purification of the first aggregate 12;
providing the second aggregate 13;
removing dust and purification of the second aggregate 13;
mixing the first aggregate 12, the second aggregate 13, the binder 11, the additive 14, and water to form a low-carbon emission mineral casting material.

The low-carbon emission mineral casting material can be poured into the mold to form a casting. To further explain, since the low-carbon emission mineral casting material of the present application does not add resin materials, such as epoxy resin, it can have better fluidity, at least higher than that of casting materials adding resin materials. The low-carbon emission mineral casting material of the present application has excellent fluidity and its performance is sufficient to fill all corners of the mold before solidification. That is to say, the low-carbon emission mineral casting material of the present application can be cast at room temperature (for example, −5° C.-50° C., preferably 15° C.-35° C., preferably 20° C.-30° C.), and then flow naturally. After filling the mold, it solidifies to form a low-carbon emission mineral casting. Therefore, the material can be filled into the mold smoothly and reliably without the need for vibration devices or other external force means. In addition, it should be noted that the low-carbon emission mineral casting material in this case can be cast even at extremely low room temperatures, such as below 0° C.

In other embodiments, in the manufacture of low-carbon emission mineral casting materials of the present application, the second aggregate 13 may not be used, and only the first aggregate 12 mainly composed of mineral may be used as the main aggregate of the casting.

In this embodiment, the binder may include tricalcium silicate, dicalcium silicate, tricalcium aluminate, tetracalcium aluminoferrite, microsilica powder (quartz powder), and other materials that can enhance strength and durability. In a preferred embodiment, tricalcium silicate, dicalcium silicate, tricalcium aluminate, and tetracalcium aluminoferrite can account for about 50% by weight of the binder.

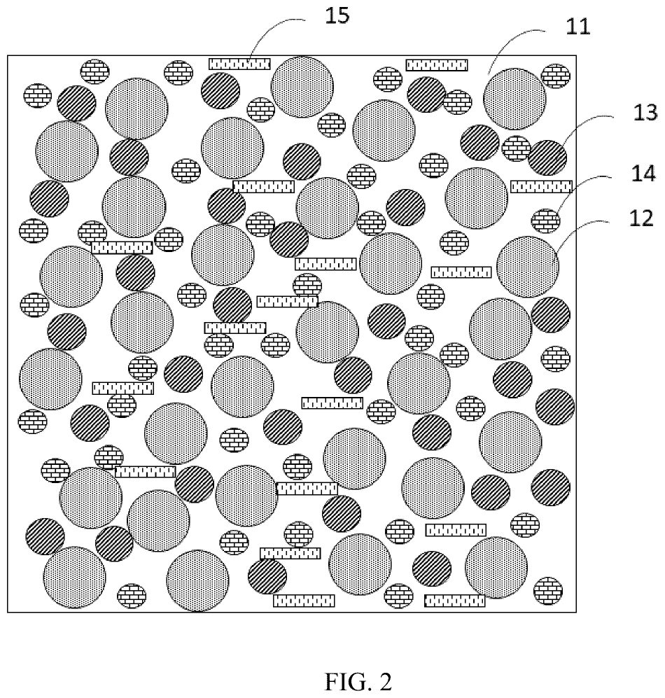

In one embodiment, as shown in FIG. 2, other materials such as steel fibers, plastic steel fibers, plastic fibers (polyethylene, polypropylene), etc that can enhance strength and durability can be reinforced fibers 15. Its length can range from 3 mm to 10 mm, preferably range from 4 mm to 6 mm. In one embodiment, a weight percentage of the reinforcing fiber 15 in the binder is less than 1%. In addition, it should be noted that since the low-carbon emission mineral casting material of the present application has a low thermal conductivity, even if plastic fibers or other reinforcing fibers 15 that are less resistant to high temperatures are added, the high temperature will not easily affect the strength of the reinforcing fibers 15 characteristic. In addition, in other embodiments, other materials that can enhance strength and durability, such as reinforcing fibers 15, may be omitted, for example, a binder 11 containing only mineral components may be used.

In addition, in a preferred embodiment, tricalcium silicate, dicalcium silicate, tricalcium aluminate, tetracalcium aluminoferrite, and microsilica powder (quartz powder) are all nanoscale powders, thus results in a dense structure.

It is further explained that during the formation process of the micro-silica powder, due to the surface tension during the phase change formation process, the micro-silica powder has an amorphous phase under the action of surface tension, and the surface is smooth. Part of the microsilica powder is an aggregate of multiple spherical particles adhered together. The microsilica powder is a material with a very high surface area and high activity. A fineness of microsilica powder is less than 1000 nanometers, an average particle diameter ranges from 100 to 300 nanometers, and a specific surface area ranges from 20-28m²/g. Its fineness and specific surface area are about 80-100 times that of cement and 50-70 times that of fly ash. Therefore, it is very suitable for bonding other substrates.

In a preferred embodiment, most of the microsilica powder is silica powder, and its particle diameter ranges from 7 nanometers to 40 nanometers, such as ranges from 10 nanometers to 20 nanometers, to facilitate the formation of dense structure. In other embodiments, the silica powder may also have other particle diameters, such as less than 300 nanometers. In addition, in one preferred embodiment, in terms of weight percentage, the microsilica powder can be composed one or more of 75% to 98% of silicon dioxide, 1.0±0.2% of alumina, 0.9±0.3% of ferric oxide, 0.7±0.1% of magnesium oxide, calcium oxide 0.3±0.1%, and Na₂O 1.3±0.2%. In addition, its bulk density is approximately 320 kg/m³ to 700 kg/m³.

In one embodiment, a hydration reaction will occur to produce hydrated calcium silicate and calcium hydroxide when the microsilica powder reacts with the silicate. Hydrated calcium silicate can have the effect of binding other substances. Microsilica powder, calcium hydroxide, and water can react to regenerate more calcium silicate gel polymer. At this time, the calcium hydroxide content decreases, as shown in the following chemical reaction:

Calcium hydroxide+microsilica powder+water→calcium silicate hydrate

Ca(OH)₂+SiO₂+H₂O→CSH

Calcium silicate gel polymer can increase an adhesion of various matrices inside the casting and help reduce permeability. At the same time, since calcium hydroxide will be reduced during this reaction, it can also improve a durability of the overall structure.

In summary, since the particles of micro-silica powder are very small, they can act as fillers and gelling materials. Micro-silica powder can be filled between the particles of each of the base materials, especially the gaps between aggregates, and the micro-silica powder can also be combined with calcium hydroxide, thus making the structure of the casting denser, stronger and with low permeability.

In one embodiment, the component of the adhesive 11 further includes calcium oxide. The particle diameter of the fine calcium oxide in the calcium oxide can range from 0.7 to 100 microns, preferably range from 20 to 80 microns. A weight percentage of finely divided calcium oxide range from 90% to 99% of calcium oxide.

In one embodiment, the binder 11 includes cement, silica, and calcium oxide. Cement includes general cement and ultrafine cement. The particle diameter of ultrafine cement ranges from 2 to 20 microns, and the weight percentage of general cement and ultrafine cement ranges from 3:1 to 5:1.

In one embodiment, silica can have two forms, namely fumed silica and precipitated silica, and a weight percentage ratio between the two can range from 1:1 to 1:50.

In one embodiment, the cement may include one or more of blast furnace slag,

fly ash, silica powder, pozzolana, calcium carbonate, silica, aluminum oxide (such as aluminum oxide), iron oxide (such as aluminum oxide), iron) and gypsum. It is further explained that the low-carbon emission mineral casting material of the present application has good impermeability and water-absorbing properties, and its water-absorbing properties depend on factors such as aggregate mix ratio, water-binder ratio, and material composition. The water absorption rate of the low-carbon emission mineral casting material of the present application is very low, about less than 0.1%. This is because the above-mentioned refined aggregates and powders make the microstructure of the casting denser. In addition, the low-carbon emission mineral casting material of the present application usually contains high-efficiency water reducing agent and other additives to improve fluidity and operating performance, thereby helping to reduce the water absorption of the final casting. Castings formed from the low-carbon emission mineral casting material of the present application also have excellent anti-seepage properties and can maintain high anti-seepage capabilities under water pressure.

Further explanation, the casting formed by the low-carbon emission mineral casting material of the present application that contains the above materials or is composed of the above materials has a thermal conductivity coefficient ranging from 1 W·m⁻¹K⁻¹ to 8 W·m⁻¹K⁻¹, a specific heat capacity ranges from 0.7 Kj·kg⁻¹K⁻¹ to 1.5 Kj·kg⁻¹K⁻¹; a linear thermal expansion coefficient, ranges from 1 10⁻⁶/K to 15 10⁻⁶/K; a compressive strength, greater than 125 MPa; a bending strength, greater than 15 MPa, and a Yang's modulus greater than 40000 MPa, and a density ranges from 2 g·cm⁻³ and 3 g·cm⁻³.

In addition, castings formed from low-carbon emission mineral casting materials are also resistant to high temperatures and can withstand temperatures of at least 450° C. while maintaining excellent mechanical and physical properties. Compared with castings containing resin materials, such as materials containing epoxy resin, the temperature that this case can withstand is at least 200° C. higher (generally, a maximum temperature range of epoxy resin is about 150° C.).

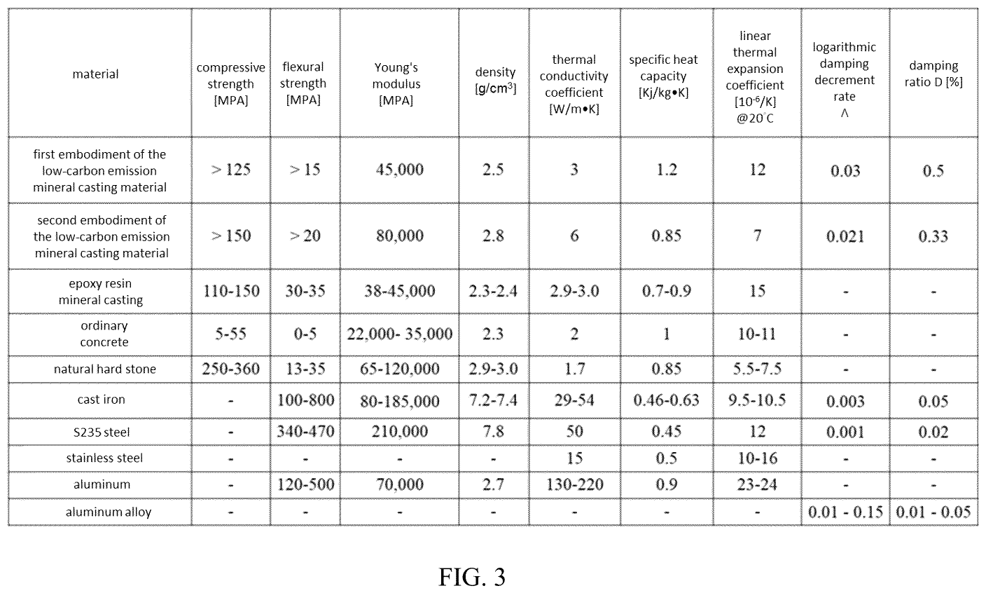

Referring to FIG. 3, in one embodiment, the thermal conductivity coefficient of the casting formed by the first embodiment of the low-carbon emission mineral casting material ranges from 2 W·m⁻¹K⁻¹ to 5 W·m⁻¹K⁻¹, for example, it can be 3.0 W·m⁻¹K⁻¹; the specific heat capacity of the casting ranges from 0.8 Kj·kg⁻¹K⁻¹ to 2.0 Kj·kg⁻¹K⁻¹, for example, it can be 1.2 Kj·kg⁻¹K⁻¹; a linear thermal expansion coefficient of the casting ranges from 8 10⁻⁶/K to 15 10⁻⁶/K, for example is 12 10⁻⁶/K; the compressive strength of the casting is greater than 125 MPa; the flexural strength of the casting is greater than 15 MPa; the Young's modulus of the casting is 45000 MPa, and a density of the casting ranges from 1.8 g·cm⁻³ to 3.3 g·cm⁻³, for example It can be 2.5 g·cm⁻³; the logarithmic damping decrement rate ranges from 0.02 to 0.04, for example, it can be 0.03; and the damping ratio can be 0.4 to 0.6, for example, it can be 0.5.

In another embodiment, the thermal conductivity coefficient of the casting formed by the second embodiment of the low-carbon emission mineral casting material ranges from 3 W·m⁻¹K⁻¹ to 9 W·m⁻¹K⁻¹, for example, it can be 6.0 W·m⁻¹K⁻¹; the specific heat capacity of the casting ranges from 0.5 Kj·kg⁻¹K⁻¹ to 1.6 Kj·kg⁻¹K⁻¹, for example, it can be 0.85 Kj·kg⁻¹K⁻¹; the linear thermal expansion coefficient of the casting ranges from 5 10⁻⁶/K to 15 10⁻⁶/K, for example, it can be 7 10⁻⁶/K; the compressive strength of the casting is greater than 150 MPa; the flexural strength of the casting is greater than 20 MPa; the Young's modulus of the casting is 80000 MPa; the density of the casting ranges from 1.8 g·cm⁻³ to 3.3 g·cm⁻³, for example, it can be 2.8 g·cm⁻³; the damping logarithmic decrement rate ranges from 0.01 to 0.03, for example, it can be 0.021; and the damping ratio ranges from 0.2 to 0.5, for example, it can be 0.33.

Further explain, the thermal conductivity coefficient of epoxy resin mineral casting ranges from 2.9 W·m⁻¹K⁻¹ to 3.0 W·m⁻¹K⁻¹; the specific heat capacity of epoxy resin mineral casting ranges from 0.7 Kj·kg⁻¹K⁻¹ to 0.9 Kj·kg⁻¹K⁻¹; the linear thermal expansion coefficient of the casting ranges from 5 10⁻⁶/K to 15 10⁻⁶/K; the compressive strength of epoxy resin mineral casting ranges from 110 MPa to 150 MPa; the flexural strength of epoxy resin mineral casting ranges from 30 MPa to 35 MPa; the Young's modulus of the epoxy resin mineral casting ranges from 38 MPA to 45000 MPa; the density of epoxy resin mineral casting ranges from 2.3 g·cm⁻³ to 2.4 g·cm⁻³.

Further explanation, the thermal conductivity coefficient of ordinary concrete is 2 W·m⁻¹K⁻¹; the specific heat capacity of ordinary concrete is 1 Kj·kg⁻¹K⁻¹; the linear thermal expansion coefficient of ordinary concrete is 10 10⁻⁶/K to 11 10⁻⁶/K; the compressive strength of ordinary concrete ranges from 5 MPA to 55 MPa; the flexural strength of ordinary concrete ranges from 0 MPA to 5 MPa; the Young's modulus of ordinary concrete ranges from 22000 MPA to 35000 MPa; the density of ordinary concrete is 2.3 g·cm⁻³.

Further explanation, the thermal conductivity coefficient of natural hard stone is 1.7 W·m⁻¹K⁻¹; the specific heat capacity of natural hard stone is 0.85 Kj·kg⁻¹K⁻¹; the linear thermal expansion coefficient of natural hard stone ranges from 5.5 10⁻⁶/K to 7.5 10⁻⁶/K; the compressive strength of natural hard stone ranges from 280 MPA to 360 MPa; the flexural strength of natural hard stone ranges from 13 MPa to 35 MPa; the Young's modulus of natural hard stone ranges from 90000 MPA to 120000 MPa; the density of natural hard stone ranges from 2.9 g·cm⁻³ to 3.0 g·cm⁻³.

Further explanation, the thermal conductivity coefficient of cast iron ranges from 29 W·m⁻¹K⁻¹ to 54 W·m⁻¹K⁻¹; the specific heat capacity of cast iron ranges from 0.46 Kj·kg⁻¹K⁻¹ to 0.63 Kj·kg⁻¹K⁻¹; the linear thermal expansion coefficient of cast iron ranges from 9.5 10⁻⁶/K to 10.5 10⁻⁶/K; the flexural strength of cast iron ranges from 100 MPa to 800 MPa; the Young's modulus of cast iron ranges from 80 MPA to 185000 MPa; the density of cast iron ranges from 7.2 g·cm⁻³ to 7.4 g·cm⁻³; the logarithmic damping attenuation rate is 0.003; and the damping ratio is 0.05.

Further explanation, the thermal conductivity coefficient of S235 steel is 50 W·m⁻¹K⁻¹; the specific heat capacity of S235 steel is 0.45 Kj·kg⁻¹K⁻¹; the linear thermal expansion coefficient of S235 steel is 12 10⁻⁶/K; The flexural strength of S235 steel ranges from 340 MPA to 470 MPa; the Young's modulus of S235 steel is 210000 MPa; the density of S235 steel is 7.8 g·cm⁻³; the logarithmic damping attenuation rate is 0.001; and the damping ratio is 0.02.

Further explanation, the thermal conductivity coefficient of aluminum ranges from 130 W·m⁻¹K⁻¹ to 220 W·m⁻¹K⁻¹; the specific heat capacity of aluminum is 0.9 Kj·kg⁻¹K⁻¹; the linear thermal expansion coefficient of aluminum ranges from 23 10⁻⁶/K to 24 10⁻⁶/K; the flexural strength ranges from 120 MPa to 500 MPa; the Young's modulus of aluminum is between 70000 MPa; the density of aluminum is 2.7 g·cm⁻³.

Further explanation, the thermal conductivity coefficient of stainless steel is 15 W·m⁻¹K⁻¹; the specific heat capacity of stainless steel is 0.5 Kj·kg⁻¹K⁻¹; the linear thermal expansion coefficient of stainless steel ranges from 10 10⁻⁶/K to 16 10⁻⁶/K.

To further explain, the damping logarithmic attenuation rate of aluminum alloy ranges from 0.01 to 0.15, and the damping ratio of aluminum alloy ranges from 0.01 to 0.05.

From the above, it can be seen that the shock-absorbing performance of the casting formed by the low-carbon emission mineral casting material of the present application is about 10 times that of cast iron (gray cast iron). Compared with cast iron, the casting formed by the low-carbon emission mineral casting material of the present application has a lower thermal conductivity coefficient, and compared with epoxy resin mineral casting, the casting formed by the low-carbon emission mineral casting material of the present application has better heat resistance and Young's modulus, and has a lower thermal expansion coefficient. In other words, the casting formed by the low-carbon emission mineral casting material of the present application has the functions of heat resistance, low thermal conductivity, low expansion coefficient, and high shock-absorbing performance.

In addition, in one embodiment, the casting formed by the low-carbon emission mineral casting material of the present application can have a width of about 3 meters, a height ranges from 2 to 4 meters, and a length of about 4 meters, therefore, at least the casting in this embodiment can have various effects of the above embodiments.

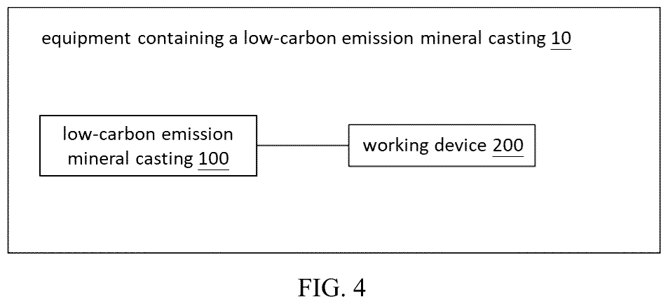

As shown in FIG. 4, the present application further provides an equipment containing low-carbon emission mineral castings 10, including a low-carbon emission mineral casting 100 and a working device 200. The low-carbon emission mineral casting 100 can be made of the low-carbon emission mineral casting material in any of the above embodiments, and the working device 200 is connected to the low-carbon emission mineral casting.

To further explain, in one embodiment, the low-carbon emission mineral casting 100 can be the base, bed, beam, machine column, spindle head, fuselage, workbench, etc. of a machine tool or other instrument. The working device 200 may be a processing platform or a working platform, such as a three-axis machining platform, a five-axis machining platform, a tool, a motor, etc.

Compared with other materials, especially commonly used cast iron, concrete and other materials, the castings formed by the low-carbon emission mineral casting material of the present application have lower thermal conductivity, sufficient compressive strength, flexural strength and Young's modulus, so it is suitable for use in equipment that requires excellent thermal insulation and vibration resistance, such as tool machines.

In addition to the above advantages, the castings formed by the low-carbon emission mineral casting material of the present application have a lower density than cast iron and most metal materials, so an overall weight of the finished product can be greatly reduced. In other words, the castings formed from the low-carbon emission mineral casting material of the present application not only have excellent mechanical properties, but also have a lightweight effect.

In summary, the present application provides low-carbon emission mineral casting materials and manufacturing methods thereof. Since the processing of minerals can significantly reduce carbon emissions compared to the manufacturing of metal materials, it is more economical and environmentally friendly. In addition, the low-carbon emission mineral casting material of the present application does not need to be heated to form a molten state during the process of forming the casting, so it can further save energy and effectively reduce the carbon footprint of the finished product.

The above is only illustrative and not restrictive. Any equivalent modifications or changes that do not depart from a spirit and scope of the present application shall be included in the appended claims.

What is claimed is:

1. A low-carbon emission mineral casting material, comprising:
a binder comprising one or more of a silicate, an aluminate or a ferroaluminate;
a first aggregate, wherein a first particle diameter of the first aggregate is less than or equal to 15 mm; and
an additive, wherein the low-carbon emission mineral casting material is cast and solidified at a room temperature to form a low carbon emission mineral casting.

2. The low-carbon emission mineral casting material as claimed in claim 1, wherein the first particle diameter of the first aggregate ranges from 5 mm to 12 mm.

3. The low-carbon emission mineral casting material as claimed in claim 2, wherein the first aggregate is one or more of gabbro, granite, basalt, andesite, conglomerate, sandstone, shale, diabase, pyroxene rock, or quartz.

4. The low-carbon emission mineral casting material as claimed in claim 1, wherein further comprises a second aggregate, a second particle diameter of the second aggregate is less than 3 mm, and wherein the second aggregate is a sandy material.

5. The low-carbon emission mineral casting material as claimed in claim 1, wherein the first aggregate is in an air-dry state and is a dust-free, angular hard stone.

6. The low-carbon emission mineral casting material as claimed in claim 1, wherein the silicate is one or more of tricalcium silicate and dicalcium silicate; wherein the aluminate is tricalcium aluminate, and wherein the iron aluminate is tetracalcium ferroaluminate.

7. The low-carbon emission mineral casting material as claimed in claim 1 further comprises an additive, wherein the additive comprises a cement modifier and a concrete shrinkage modifier.

8. The low-carbon emission mineral casting material as claimed in claim 1, wherein the low-carbon emission mineral casting material forms a casting with a thermal conductivity coefficient ranges from 2 W·m⁻¹K⁻¹ to 7 W·m⁻¹K⁻¹, and a specific heat capacity ranges from 0.7 Kj·kg⁻¹K⁻¹ to 1.5 Kj·kg⁻¹K⁻¹, and a linear thermal expansion coefficient ranges from 5 10⁻⁶/K to 15 10⁻⁶/K, and a compressive strength greater than 125 MPa, a flexural strength greater than 15 MPa, and a Young's modulus greater than 40,000 MPa, and a density ranges from 2 g·cm⁻³ to 3 g·cm⁻³.

9. The low-carbon emission mineral casting material as claimed in claim 4, wherein a weight percentage of the first aggregate and the second aggregate in the low-carbon emission mineral casting material ranges from 0% to 80%, wherein a weight percentage of the binder in the low-carbon emission mineral casting material ranges from 35% to 45%, and wherein a weight percentage of the additives in the low-carbon emission mineral casting material ranges from 2% to 8%.

10. A method of manufacturing a low-carbon emission mineral casting material, comprising:
cracking an mineral raw material to form a plurality of broken mineral raw materials;
screening the plurality of broken mineral raw materials according to a first particle diameter to obtain a first aggregate;
for the first aggregate; and
mixing the first aggregate, a binder, an additive and water to form the low-carbon emission mineral casting material;
wherein the binder comprises tricalcium silicate, dicalcium silicate, tricalcium aluminate, and tetracalcium ferroaluminate, wherein a first particle diameter of the first aggregate is less than or equal to 15 mm, wherein the low-carbon emission mineral casting material is casting at room temperature, and wherein a mold is filled under natural flow and solidified to form a low-carbon emission mineral casting.

11. The method of manufacturing the low-carbon emission mineral casting material as claimed in claim 10, wherein the first particle diameter of the first aggregate ranges from 5 mm to 12 mm.

12. The method of manufacturing the low-carbon emission mineral casting material as claimed in claim 10, wherein the first aggregate is one or more of gabbro, granite, basalt, andesite, conglomerate, sandstone, shale, diabase, pyroxene rock, or quartz.

13. The method of manufacturing the low-carbon emission mineral casting material as claimed in claim 10, wherein the first aggregate is a hard stone.

14. The method of manufacturing the low-carbon emission mineral casting material as claimed in claim 10, wherein a weight percentage of the first aggregate and the second aggregate in the low-carbon emission mineral casting material ranges from 0% to 80%, wherein a weight percentage of the binder in the low-carbon emission mineral casting material ranges from 35% to 45%, and wherein a weight percentage of water in the low-carbon emission mineral casting material ranges from 5% to 12%.

15. The method of manufacturing the low-carbon emission mineral casting material as claimed in claim 10, wherein the low-carbon emission mineral casting material forms a casting with a thermal conductivity coefficient ranges from 2 W·m⁻¹K⁻¹ to 7 W·m⁻¹K⁻¹, and a specific heat capacity ranges from 0.7 Kj·kg⁻¹K⁻¹ to 1.5 Kj·kg⁻¹K⁻¹, and a linear thermal expansion coefficient ranges from 5 10⁻⁶/K to 15 10⁻⁶/K, and a compressive strength greater than 125 MPa, a flexural strength greater than 15 MPa, and a Young's modulus greater than 40,000 MPa, and a density ranges from 2 g·cm⁻³ to 3 g·cm⁻³.

16. An equipment containing a low-carbon emission mineral casting, comprising:
a low-carbon emission mineral casting made of the low-carbon emission mineral casting material as claimed in claim 1; and
a working device connected with the low-carbon emission mineral casting.
